(19) United States
(12) Patent Application Publication
(10) Pub. No.: US 2008/0008186 A1
(43) Pub. Date: Jan. 10, 2008

(54) Apparatus and method for enhancing block Ack in WLAN

(75) Inventors: Guoping Fan, Suwon-si (KR); Chang-yeul Kwon, Yongin-si (KR); Moon-seok Han, Suwon-si (KR); Dong-hwi Roh, Seocho-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/727,084

(22) Filed: Mar. 23, 2007

(30) Foreign Application Priority Data
Jul. 7, 2006 (KR) 10-2006-0064049

(51) Int. Cl. H04L 12/56

(52) U.S. Cl. 370/394

(57) ABSTRACT

An apparatus and method of enhancing a block Ack in a WLAN is disclosed. The apparatus includes a frame verification module receiving a plurality of data frames and selecting erroneous frames, a sequence control mapping module mapping sequence numbers of the selected frames with spoofing numbers, and a frame combining module combining the mapped frames with other sequence frames and transmitting the combined frames. The data frames include spoofing sequence control frames with which the spoofing sequence numbers are mapped.

### CROSS-REFERENCE TO RELATED APPLICATION

This application claims priority from Korean Patent Application No. 10-2006-64049 filed on Jul. 7, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to enhancing a block acknowledgement (Ack) in a wireless network, and more particularly, to an apparatus and method for enhancing a block Ack, which can stably transmit data to a user without interruption by improving a block Ack in a digital appliance using a wireless network according to the IEEE 802.11 standard.

2. Description of the Related Art

Wireless local area network (WLAN) technology, which uses radio frequencies rather than a wired cable as its transmission medium, was initially developed to be used for military purposes. After the civil use of the WLAN technology was permitted, it has been restrictively used in the special environments such as a warehouse, a department store, a hospital, and so forth, in which a wired LAN can be difficult to construct.

However, the WLAN has been rapidly popularized after the Institute of Electrical and Electronics Engineers (IEEE) announced the 802.11 WLAN standard and Wireless Ethernet Capability Alliance (WECA), which was changed to WiFi in 2002, guaranteed compatibilities among diverse equipments manufactured by many manufacturers.

Due to performance/price competition among manufacturers, the WLAN has experienced a decreasing cost similar to that of Ethernet, so that high-priced WLAN equipment has recently become lower in price than a mobile phone.

The WLAN has been generally used for industrial network solutions. However, with the recent increase of mobile workers who process their business outside their offices using notebooks and personal digital assistants (PDAs), the WLAN has also been used for the purpose of a public WLAN service that provides Internet access services to the mobile workers.

Furthermore, with the rapid price-down from the deeper competition and scale economics, the WLAN has been diversely adapted to digital home appliances as well as computers such as notebooks, PDAs, and so forth, and thus is expected to serve as a critical technology for realizing ubiquitous networks.

On the other hand, the IEEE 802.11 standard provides detailed specifications of Media Access Control (MAC) and physical layers (hereinafter referred to as “PHY”).

In the IEEE 802.11 standard, the basic mechanism for media access is a Distributed Coordination Function (DCF), which is a route sharing protocol.

Here, the route sharing protocol is a concept of random access of all devices in the same basic service set on the basis of Carrier Sense Multiple Access with Collision Avoidance (CSMA/CA).

Further, a wireless transceiver is adopted to cope with previous collision avoidance because it cannot perform sending/receiving at the same time and thus cannot perform collision sensing.

The IEEE 802.11 and 802.11b standards are adopted to a wireless Ethernet LAN and operate in a frequency of 2.4 GHz. A data rate in the 802.11 standard is 1 or 2 Mbps and a data rate in the IEEE 802.11b standard is 5.5 or 11 Mbps.

The IEEE 802.11b standard Phase Shift Keying (PSK) modulation and the IEEE 802.11b standard uses a Complementary Code Keying (CCK) standard.

Further, the IEEE 802.11a standard is adopted to an Asynchronous Transfer Mode (ATM) system and operates in the frequency range of 5 GHz to 6 GHz. Its modulation type is an Orthogonal Frequency Division Multiplexing (OFDM) and it is not compatible with the IEEE 802.11b standard. The data rate is a maximum of 54 Mbps, but in a common communication, it may be 6 Mbps, 12 Mbps, and 24 Mbps.

The IEEE 802.11e standard is the first wireless standard for use in homes and offices.

This is additionally provided with the support of Quality of Service (QoS) and multimedia while maintaining the compatibility with the existing IEEE 802.11b and 802.11a standards.

In the IEEE 802.11e standard, in order to enhance the performance and the quality of data, a Traffic Stream (TS) is defined according to the traffic characteristics and it is identified by a Traffic Identifier (TID).

Each TS enhances the performance of MAC using a method of block Ack.

That is, several frames are transmitted with a No-Ack method, and the transmission is confirmed by receiving a block Ack frame as a response to Block Ack Request (BAR) frame transmission.

In the IEEE 802.11n standard, MAC protocol data units are aggregated and transmitted, and a compressed block Ack is received as a response.

At this time, an erroneous frame is received through re-transmission and is processed with reordering through being stored in a receiving buffer before the transmission to an upper layer.

In the IEEE 802.11e standard, when a data frame is sent from a WLAN source to a destination, MAC and PHY layers of the WLAN destination respectively constitute headers, which are transmitted while being added to data.

A receiving buffer is set in the WLAN source to store the received frames.

FIG. 1 is a flowchart illustrating a related art procedure of receiving a block Ack.

For convenience of explanation, it is assumed that the number of the data frames that can be transmitted at a time is “8”.

When an originator 101 transmits data frames to a recipient 102 and requests a block Ack (S101), the recipient 102 checks for an error in the received data frames, and if there is an erroneous frame, the recipient transmits the block Ack to the originator, adding corresponding information in a bit map (S102).

At this time, bit map information is indicated as “1” and “0” in the case of a normal frame and an erroneous frame, respectively.

The originator 101 checks the information of the erroneous frame included in the block Ack and re-transmits only the corresponding frame to the recipient 102 (S103).

The recipient 102 checks the validity of the frame re-received due to an error, and if there is no error, transmits to the originator 101 information notifying that all the data frames are normal as a block Ack, while including it in a bit map (S104).

The related art technology as described above has a problem that since the length of data frames that can be transmitted at a time is defined, an erroneous frame and the next data frame to be transmitted cannot be continuously transmitted.

Since only the corresponding erroneous frame is re-transmitted and then the block Ack for the corresponding frame should be re-transmitted, the efficiency of data transmission may be lowered and discontinuous information may be provided.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method of enhancing block Ack in a WLAN to stably transmit data.

The present invention also provides a user with continuous data without interruption through stable transmission of data.

According to an aspect of the present invention, there is provided an apparatus for enhancing a block Ack in a WLAN, the apparatus including a frame verification module receiving a plurality of data frames and selecting erroneous frames, a sequence control mapping module mapping sequence numbers of the selected frames with spoofing numbers, and a frame combining module combining the mapped frames with other sequence frames and transmitting the combined frames, wherein the data frames include spoofing sequence control frames with which the spoofing sequence numbers are mapped.

According to another aspect of the present invention, there is provided a method of enhancing a block Ack in a WLAN, the method including receiving a plurality of data frames and selecting erroneous frames, sequence-control-mapping sequence numbers of the selected frames with spoofing numbers, and combining the mapped frames with other sequence frames and transmitting the combined frames, wherein the data frames include spoofing sequence control frames with which the spoofing sequence numbers are mapped.

### BRIEF DESCRIPTION OF THE DRAWINGS

The above and other aspects of the present invention will be more apparent from the following detailed description of exemplary embodiments taken in conjunction with the accompanying drawings, in which:

FIG. 1 is a flowchart illustrating a related art procedure of receiving a block Ack;

FIG. 2 is a block diagram illustrating the construction of an apparatus for enhancing a block Ack in a WLAN according to an exemplary embodiment of the present invention;

FIG. 3 is a view illustrating the structures of an existing data frame and a data frame according to an exemplary embodiment of the present invention;

FIG. 4 is a view illustrating the original sequence control according to an exemplary embodiment of the present invention and the spoofing sequence control mapped onto the original sequence control;

FIG. 5 is a view illustrating the original sequence control according to another exemplary embodiment of the present invention and the spoofing sequence control mapped onto the original sequence control;

FIG. 6 is a flowchart illustrating a procedure of enhancing a block Ack in a WLAN according to an exemplary embodiment of the present invention;

FIG. 7 is a graphical view illustrating a test result showing stable block sizes upon data transmission according to an exemplary embodiment of the present invention;

FIG. 8 is a graphical view illustrating a test result showing throughput for bit error rate according to an exemplary embodiment of the present invention; and

FIG. 9 is a graphical view illustrating the comparison results showing the numbers of the blocks required when 1000 frames are transmitted at the same bit error rate according to a conventional method and a method according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are provided to assist those of ordinary skill in the art in a comprehensive understanding of the invention, and the present invention is only defined within the scope of the appended claims. In the entire description of the exemplary embodiments, the same drawing reference numerals are used for the same elements across various figures.

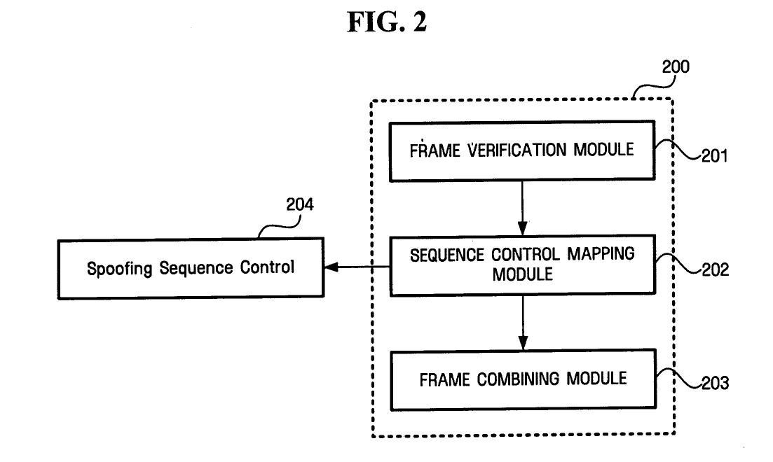

FIG. 2 is a block diagram illustrating the construction of an apparatus for enhancing a block Ack in a WLAN according to an exemplary embodiment of the present invention.

The apparatus 200 for enhancing a block Ack in a WLAN includes a frame verification module 201 which receives a plurality of data frames and checks for an erroneous frame among the received data frames, a sequence control mapping module 202 which maps the sequence number of an erroneous frame with a spoofing value, and a frame combining module 203 which transmits the erroneous frame while combining with other frames continuous from the erroneous frame, wherein the data frame includes a spoofing sequence control frame 204 in which the spoofing sequence number is mapped.

In the exemplary embodiments of the present invention, the term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

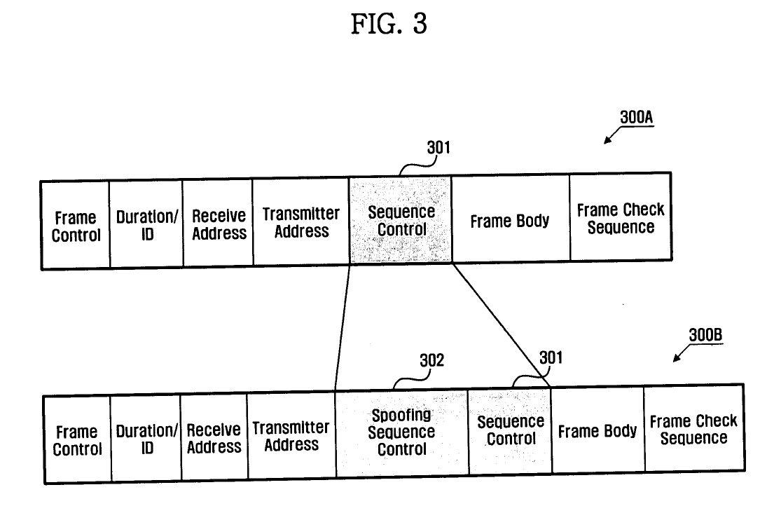

FIG. 3 is a view illustrating the structures of an existing data frame 300A and a data frame 300B according to an exemplary embodiment of the present invention.

The data frame structure 300 according to an exemplary embodiment of the present invention includes an original sequence control 301 and a spoofing sequence control 302 mapped onto the sequence control.

The spoofing sequence control 302 is a field where the mapping value for the original sequence control 301 mapped in the sequence control mapping module 202 is recorded, and serves to enable discontinuous sequence control due to an error to be viewed continuously.

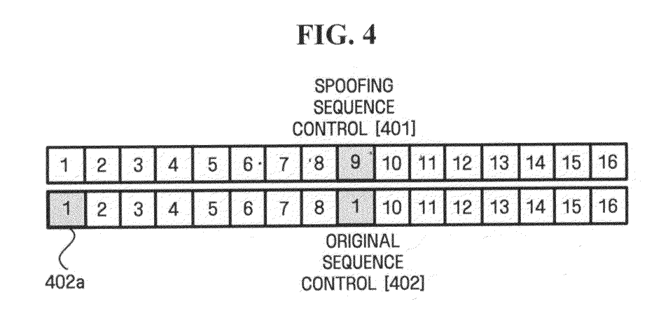

FIG. 4 is a view illustrating the original sequence control according to an exemplary embodiment of the present invention and the spoofing sequence control mapped onto the original sequence control.

It is assumed that maximum eight data frames, i.e., first to eighth data frames, can be transmitted at a time from an originator.

If there is no error-generated data frame among eight data frames transmitted from the originator, a recipient will transmit to the originator a block Ack in that all eight data frames are normally received, and the originator will transmit ninth to sixteenth data frames continuously.

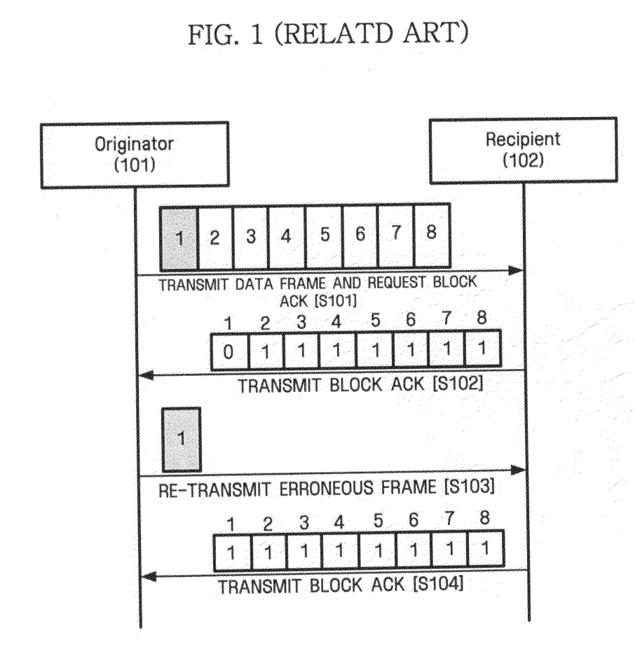

However, if an error is generated in the first data frame 402a among the first to eighth data frames, as mentioned in the description of the related art with reference to FIG. 1, there was a problem in that the originator cannot transmit the data frame continuously and re-transmits the first erroneous data frame so that the data frames are transmitted discontinuously.

In order to solve the problem of the discontinuous transmission of the data frames, the present invention adopts a spoofing sequence control 401.

If an error is generated in the first data frame 402a among the first to eighth data frames transmitted from the originator, the sequence control mapping module 202 maps “1”, which is the sequence number of the erroneous first data frame 402a, with “9”, a ninth spoofing value continuous to the first to eighth values, and refers to the original sequence number and the mapped spoofing value while storing them in a specified storage.

The frame combining module 203 thus transmits “9”, combining with tenth to sixteenth data frames continuous to “9”.

That is, with adopting the spoofing sequence control, even if there is an erroneous frame among the data frames, the data frames are transmitted as being apparently continuous.

For reference, the numbers denoted in the original sequence control in FIG. 4 are not so important. The gist of the present invention is to transmit continuous data frames including the erroneous data frame, using the spoofing sequence control 401.

For example, although a question may arise where “9” is located in the original sequence control 402 in FIG. 4, it is merely an exemplary number. It is important to transmit the data frames continuously using the spoofing sequence control 401, without exceeding the number of the maximum data frames.

Further, the sequence control mapping module 202 should be installed on both originator and recipient because it should de-map, in the recipient, the spoofing sequence control mapped in the originator.

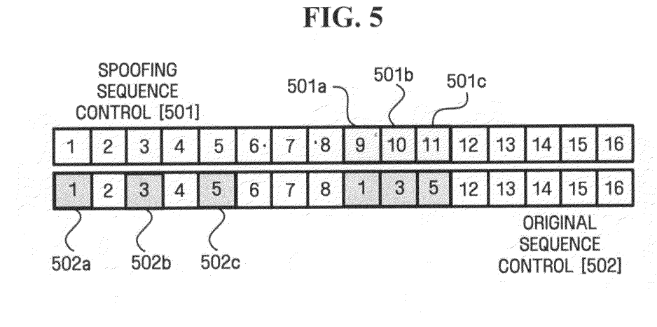

FIG. 5 is a view illustrating the original sequence control according to another exemplary embodiment of the present invention and the spoofing sequence control mapped to the original sequence control.

As described with reference to FIG. 4, if it is assumed that the originator can transmit eight data frames, i.e., first to eighth data frames, at a time and errors are generated at the first data frame 502a, the data third frame 502b, and the fifth data frame 502c, the sequence control mapping module 202 maps “1”, “3”, and “5”, which are the sequence numbers of the erroneous first, third and fifth data frames 502a, 502b and 502c, with “9” 501a, “10” 501b, and “11” 501c that are the spoofing values continuous to the first to eighth values, “9”, and “10”, respectively, and refers to the original sequence numbers and the spoofing values while storing them in a specified storage.

The frame combining module 203 then transmits the twelfth to the sixteenth data frames continuous to “11” while combining them.

The frame combining module 203 controls a length of the spoofing sequence control depending upon the number of the erroneous data frames and combines the rest data frames continuous thereto suitably to the sizes of the transmittable data frames.

Moreover, the frame combining module 203 transmits the original sequence number rather than spoofing value when transmitting the data frame to the upper layer.

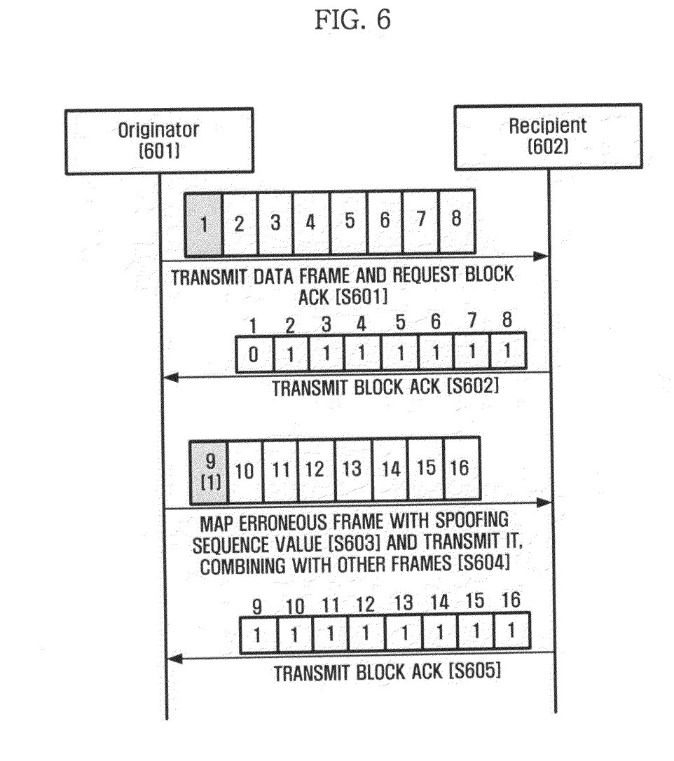

FIG. 6 is a flowchart illustrating a procedure of enhancing a block Ack in a WLAN according to an exemplary embodiment of the present invention.

For convenience of explanation, it is assumed that eight data frames, i.e., the first to eighth data frames, can be transmitted at a time and an error is generated at the first data frame.

When an originator 601 transmits data frames to a recipient 602 and requests a block Ack (S601), the frame verification module 201 of the recipient 602 checks for an erroneous frame among the received data frames, and if there is an erroneous frame, the recipient transmits the block Ack to the originator, adding corresponding information in a bit map (S602).

At this time, bit map information is indicated as “1” and “0” in the case of a normal frame and an erroneous frame, respectively.

The originator 601 checks the information of the erroneous frame included in the block Ack and maps the sequence number of the erroneous frame with the spoofing sequence number using the sequence control mapping module 202 (S603).

After operation S603, the frame combining module 203 transmits the erroneous frame with other frames while continuously combining (S604).

At this time, the frame combining module 203 controls the length of the spoofing sequence control depending upon the number of erroneous frames and combines the rest continuous data frames therewith suitably to the size of the transmittable data frame.

The recipient 602 checks the validity of the received frame, and if there is no error, transmits to the originator 601 information notifying that all the data frames are normal as a block Ack, while including it in a bit map (S605).

If data is transmitted to the upper layer after operation S605, the frame combining module includes the original sequence number other than the spoofing sequence number mapped in operation S603.

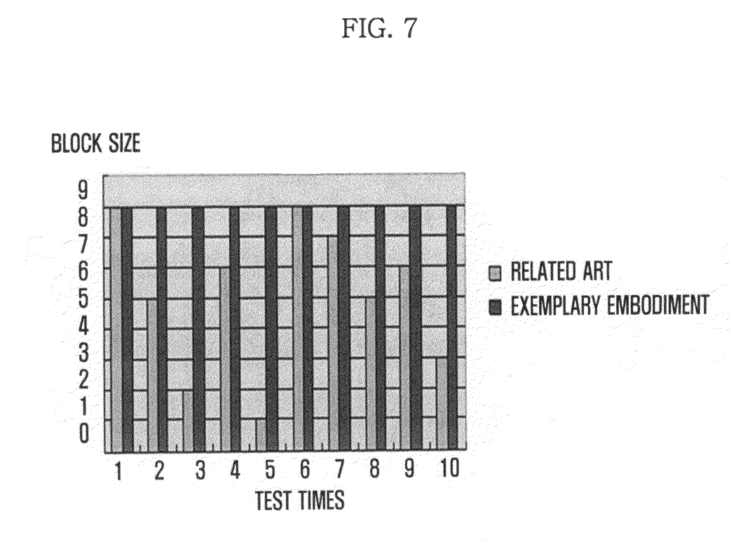

FIG. 7 is a graphical view illustrating a test result showing stable block sizes upon data transmission according to an exemplary embodiment of the present invention.

In the case where the maximum transmission size is limited to “8”, as illustrated in FIG. 7, it can be known that the conventional data transmission method shows considerably variable results in its transmission size at every test, whereas the data transmission method according to an exemplary embodiment of the present invention shows reaching “8”, the maximum size, at every test so that it is possible to transmit data stably.

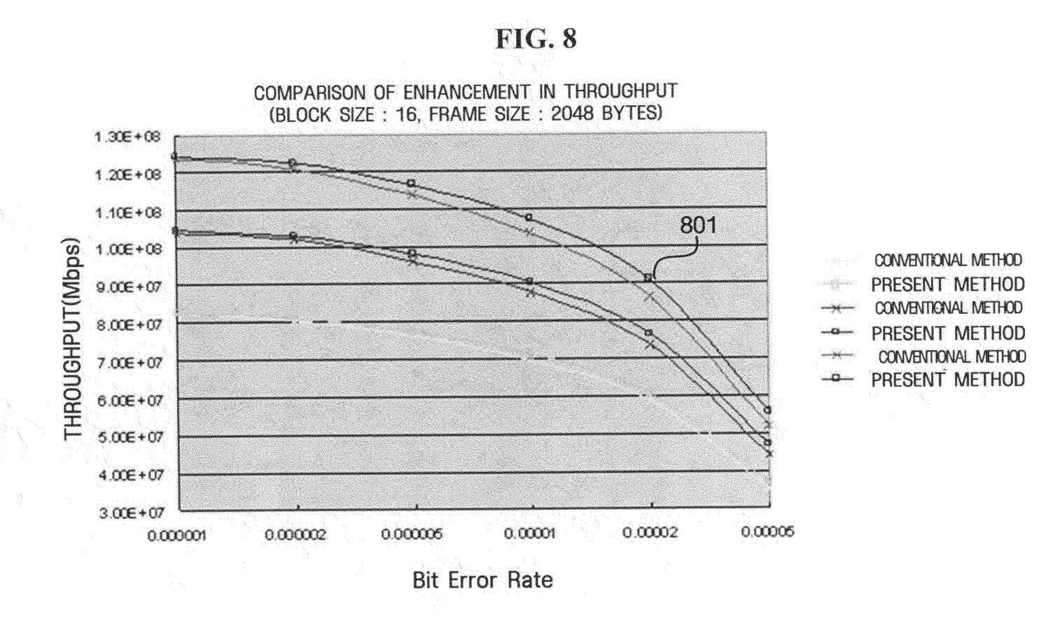

FIG. 8 is a graphical view illustrating a test result showing throughput for bit error rate according to an exemplary embodiment of the present invention.

The block size is “16” at maximum, and it can be known that when the bit error rate has the same value of 0.00002, the data transmission method 801 according to an exemplary embodiment of the present invention transmits the greater quantity of data as compared to the prior art.

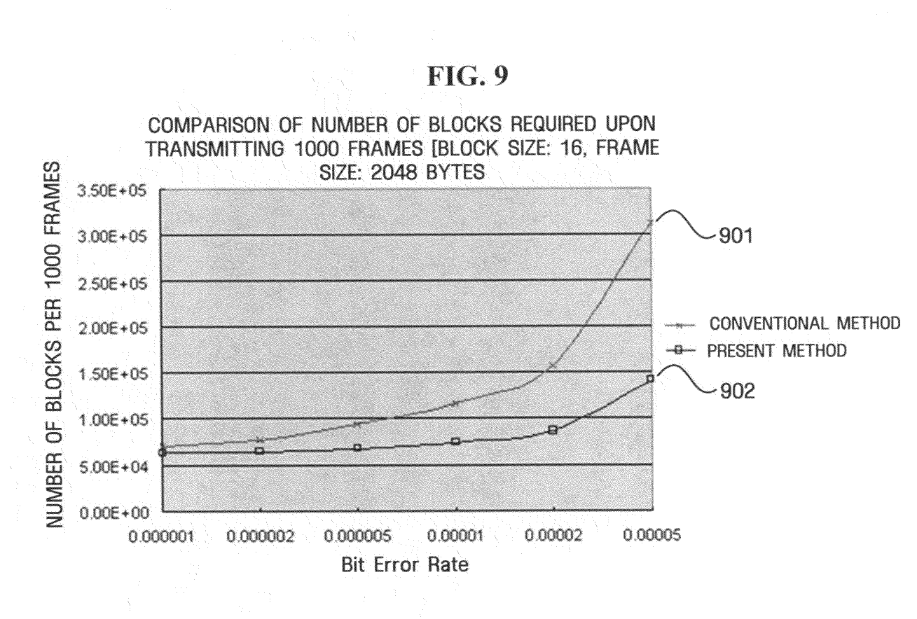

FIG. 9 is a graphical view illustrating the comparison results showing the numbers of the blocks required when 1000 frames are transmitted at the same bit error rates according to a related art method and a method according to an exemplary embodiment of the present invention.

The block size is “16” at maximum, and it can be known that when the bit error rate has the same value of 0.00005, the conventional data transmission method 901 requires “311,554” blocks, whereas the data transmission method 902 according to an exemplary embodiment of the present invention requires “141,433” blocks so that the present method can transmit the same quantity of data as those of conventional method with less blocks (at ⅓ level) than the conventional method.

As described above, the apparatus and method of enhancing a block Ack in a WLAN may have one or more effects as follows.

The data can be stably transmitted through the apparatus and method of enhancing a block Ack in a WLAN.

In addition, continuous data can be stably provided to a user without interruption.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for enhancing a block Ack in a WLAN, the apparatus comprising:
a frame verification module which receives a plurality of data frames and selects a frame which is erroneous among the plurality of data frames;
a sequence control mapping module which maps a sequence number of the selected frame with a spoofing number; and
a frame combining module which combines the selected frame which is mapped by the sequence control mapping unit with other data frames continuous with the selected frame and transmits the combined frames;
wherein the data frames include spoofing sequence control frames with which spoofing sequence numbers are mapped.

2. The apparatus of claim 1, wherein the sequence control mapping module stores in a specified storage a sequence number of the selected frame and the spoofing number mapped with the sequence number.

3. The apparatus of claim 2, wherein the sequence control mapping module is installed on both an originator which transmits the data frames and a recipient which receives the data frames.

4. The apparatus of claim 1, wherein the frame combining module controls a length of the spoofing sequence control depending upon a number of erroneous frames.

5. The apparatus of claim 1, wherein the frame combining module includes original sequence numbers rather than spoofing numbers when transmitting the data frames to an upper layer.

6. A method of enhancing a block Ack in a WLAN, the method comprising:
receiving a plurality of data frames and selecting a frame which is erroneous among the plurality of data frames;
sequence-control-mapping a sequence number of the selected frame with a spoofing number; and
combining the selected frame with other data frames continuous with the erroneous data frame and transmitting the combined frames;
wherein the data frames include spoofing sequence control frames with which spoofing sequence numbers are mapped.

7. The method of claim 6, wherein the sequence-control-mapping comprises storing in a specified storage the sequence number of the selected frame and the spoofing number mapped with the sequence number.

8. The method of claim 6, wherein the combining comprises controlling a length of the spoofing sequence control frame depending upon a number of erroneous frames.

9. The method of claim 6, wherein the combining includes original sequence numbers rather than spoofing numbers when transmitting the data frames to an upper layer.
